(19) United States
(12) Patent Application Publication
(10) Pub. No.: US 2015/0317611 A1
(43) Pub. Date: Nov. 5, 2015

(54) METHOD AND SYSTEM FOR PROVIDING PARTICIPATION VALIDATIONS

(71) Applicant: SECURE ACCREDITATION SOLUTIONS TECHNOLOGIES, S.L., Barcelona (ES)

(72) Inventor: Louis TAG, Barcelona (ES)

(21) Appl. No.: 14/647,763

(22) PCT Filed: Nov. 27, 2013
(86) PCT No.: PCT/EP2013/074808

§ 371 Date: May 27, 2015

Related U.S. Application Data
(60) Provisional application No. 61/730,166, filed on Nov. 27, 2012.

(30) Foreign Application Priority Data
Nov. 27, 2012 (EP) 12007967.8

(51) Int. Cl. G06Q 10/10; H04L 29/06; G06Q 10/02; G06F 17/27

(52) U.S. Cl. CPC G06Q 10/1093; G06F 17/2705; H04L 67/42; G06Q 10/02

(57) ABSTRACT

A method for providing a participation validation of a first client for participation in at least one event of a plurality of events to a second client and providing event information on the at least one event to the first client, the method comprising steps being performed by a server computer. The steps are accessing at least one first database comprising data associated with the first client, classifying the data whether it is related to participation in the event or not, parsing the data that is related to participation in the event, providing, to the second client, a participation validation at a predetermined time before the at least one event occurs, accessing at least one second database comprising data associated with the plurality of events, obtaining event information associated with the at least one event based on the parsed data, and providing, to the first client, the event information on the at least one event at a predetermined time before the at least one event occurs, in a format that is independent of the accessed at least one second database and the second client.

The invention is related to a method and a corresponding system for providing a participation validation of a first client for participation in at least one event of a plurality of events to a second client.

### STATE OF THE ART

Providing participation validation is commonly known. As an example, each company airline, like Lufthansa, provide online platforms, for example web pages, where a passenger can check-in via the internet, thereby sending participation information to the airline that the passenger will participate in the event, in this case the booked flight. However, such web pages or portals exist for every airline or company separately and most of the processes are up to the user to be processed.

### Technical Problem

Therefore, a technical problem that is to be solved by the method and the system for providing participation validations is to provide participation validations and event-associated information in a centralized way.

This problem is solved by the method according to claim 1.

Preferred embodiments of the invention are disclosed in the dependent claim.

According to one embodiment, the method for providing a participation validation of a first client for participation in at least one event of a plurality of events to a second client and providing event information on the at least one event to the first client, comprises steps being performed by a server-computer wherein these steps are accessing at least one first database comprising data associated with the first client, classifying the data whether it is related to participation in the event or not, parsing the data that is related to participation in the event in order to obtain event identifying information which identifies an event, providing, to the second client, a participation validation at a predetermined time before the event occurs, accessing at least one second database comprising data associated with the plurality of events, obtaining event information associated with the event based on the parsed data, and providing, to the first client, the event information on the event at a predetermined time before the event occurs, in a format that is independent of the accessed at least one second database and the second client. This method allows for automatically querying different databases wherein one database is associated with the first client, for example a passenger, and the second database is associated with a second client, for example an airline or airline associated clients as departure control systems, airport operating databases or airline hosts, reservation and travel distribution systems. Providing such a server computer that has access to those databases, providing participation validations and, on the other hand, event information can be achieved in a centralized way without further input from any of the clients.

In another embodiment, the method is characterized in that the event is a flight, and the data related to the participation in the event is data related to booking the flight, and the participation validation of the first client is a check-in for the flight and the information associated with the event is a timetable for the flight. By applying the method to flight booking and check-in, a passenger will automatically be checked-in in advance of the event and, further, will receive a timetable for the flight that may take into account delays, or further information like the gate.

In a further embodiment, the method is characterized in that accessing the at least one first database comprises accessing an e-mail account and/or a social network account and/or a timetable or calendar associated with the first client, and accessing at least one second database comprises accessing at least one database of a provider of the at least one event. By accessing such databases that are associated with e-mail accounts or social network accounts, or accessing the timetable or calendar that may be stored on a mobile device or tablet, allows the method to obtain detailed information on whether or not the first client will participate in a given event and, further, for example a booking approval that was sent by the second client can be used to monitor the event history for ensuring that the participation validation is timely filed.

In a further embodiment, the method is characterized in that providing the event information comprises providing the event information in a printable format or a format that can be viewed on a mobile device associated with the first client, depending on the state of the first client. This allows, for example in case a mobile device is associated with the first client, for providing the event information based on the position or the battery service life in a suitable format.

In a further embodiment, event information further includes information on the requirements of the participation validation and providing the event information includes providing information dependent on the requirements of the participation validation. As an example, It could be further required to not only send a participation validation to the second client but also that the first client gets into direct contact with the second client or only has a specific time limit to undertake further actions. Such information can be included in the event information.

In another embodiment, the method is characterized in that parsing the data that is related to participation in the event comprises a first parsing step, the first parsing step being performed automatically by a parsing unit and yielding first parsed data. Further, an analyzing step, the analyzing step being performed automatically by an analyzing unit and yielding a judgment on whether the first parsed data is reliable or not, based on an analysis of the first parsed data and, still further, a second optional parsing step, being performed either manually by an operator or automatically by the parsing unit on the first parsed data, based on the outcome of the analyzing step and yielding the parsed data, wherein the first parsed data of the first parsing step or the parsed data of the second optional parsing step contains the event identifying information. Therefore, the parsing process can be provided in a more efficient manner, i.e. in cases where errors occur in the first parsing step, these errors can be detected and, based on a corresponding judgment, the parsing process can again be performed either manually by an operator in order to avoid probably not so easily evitable errors or, again, automatically, as in the first parsing step, in case problems that probably occurred can be overcome.

In a further embodiment, the method is characterized in that the parsing unit is updated based on the parsed data obtained on the second parsing step. By providing such a learning technique to the parsing unit, this parsing unit can cope with evolving databases, thereby further minimizing input that could be required by the first client.

In a still further embodiment, the method is characterized in that credential information for accessing the at least one first database is stored, at the server-computer, in a profile associated with the first client. Thereby, the at least one first database can be accessed without having to, or requiring, access through the first client, hence allowing for directly accessing the at least one further database.

According to a further embodiment, the method is characterized in that providing, to the second client, a participation validation at a predetermined time before the event occurs comprises a first providing step in which a first participation validation is provided a confirming step in which the second client transmits to the server-computer a confirmation of the participation validation being valid or a refusal of the participation validation a second providing step which is carried out in case a refusal of the participation validation was sent and which is carried out manually by an operator that transmits a further participation validation to the second client and updates the server-computer upon the result. Thereby it is on the one hand secured that a participation validation is transmitted to the second client and further the server-computer can be updated upon changes related to the participation validations.

### BRIEF DESCRIPTION OF THE FIGURES

FIG. 1—Schematic depiction of the system underlying the method

FIG. 2—Schematic view of the information flow of the method

FIG. 3—Schematic view of the access options of the server computer to the first and second databases

FIG. 4—Flow diagram of the method according to one embodiment

### DETAILED DESCRIPTION

The system 100 that may be utilized in order to conduct the method for providing a participation validation of a first client for participation in at least one event of a plurality of events to a second client and providing event information on the at least one event to the first client comprises one fixed component 101 which is the server computer 101. This server computer 101 includes at least a parsing unit 111 and, according to some embodiments, also an analyzing unit 112. Further, a classifier 113 may be included as a separate component although this component may also be provided with the parsing component 111. In view of the manifold possibilities to provide suitable hardware architecture, the server computer 101 in this context may be a personal computer, or a server or include both and even an hardware architecture including a plurality of servers and/or personal computers as well as other associated devices can be thought of. However, in the following description, reference will only be made to the term server computer 101. The server computer 101 can get in contact with the first client 102 and the second client 103. Both the first and second clients are no specific part of the system. In contrast, the first client 102 is preferably a customer 121 that wants to use the service provided by the server computer 101, whereas the second client 103 is preferably a company 131 or a provider of services, i.e. the events.

Associated with the first client 102 there is preferably a mobile device 122, for example in the form of a smart phone, notebook, or tablet PC or any other portable device capable of processing data and displaying information. Further, databases that contain information and are associated with the first client 102 can be provided separately from the mobile device 122. Such databases can include, but are not limited to, social networks 124 and e-mail accounts 123. It is preferred that the server computer 101 can access information associated with the first client 102 via the mobile device 122 through an application 125. Further, the customer 121, i.e. the entity associated with the first client 102 can access the services provided by the server computer 101 via the application 125. The application may be installed on the mobile device. It is also possible to not provide a specific application, but access to a web portal that offers the same services but yielding the advantage that storing of data can be done for example in a cloud-network. Hence, on the mobile device no further data needs to be stored.

On the other side, the second client 103 that may be a company 131, or any other entity, includes, or has associated therewith, a plurality of databases 132 and 133. A web portal, for example a webpage, can be associated with the second client 103. This web portal can be related to or associated with aviation related IT systems such as airline hosts, airport operating databases, reservation and departure control systems. Applying certain credentials of the first client 102 (for example login names and passwords, data strings, flight numbers, reservation numbers, globally unique identifiers) to the second client 103, or its associated databases or web pages, the server computer 101 can automatically access the database and the web portal 132, 133, and 134 in order to either transmit a participation validation for a certain event, i.e. confirming that the customer 121 will participate in an event that is provided by the second client 103 and, further, the server-computer can obtain information related to this event by applying the credentials to the databases and the web pages and transmit it to the client.

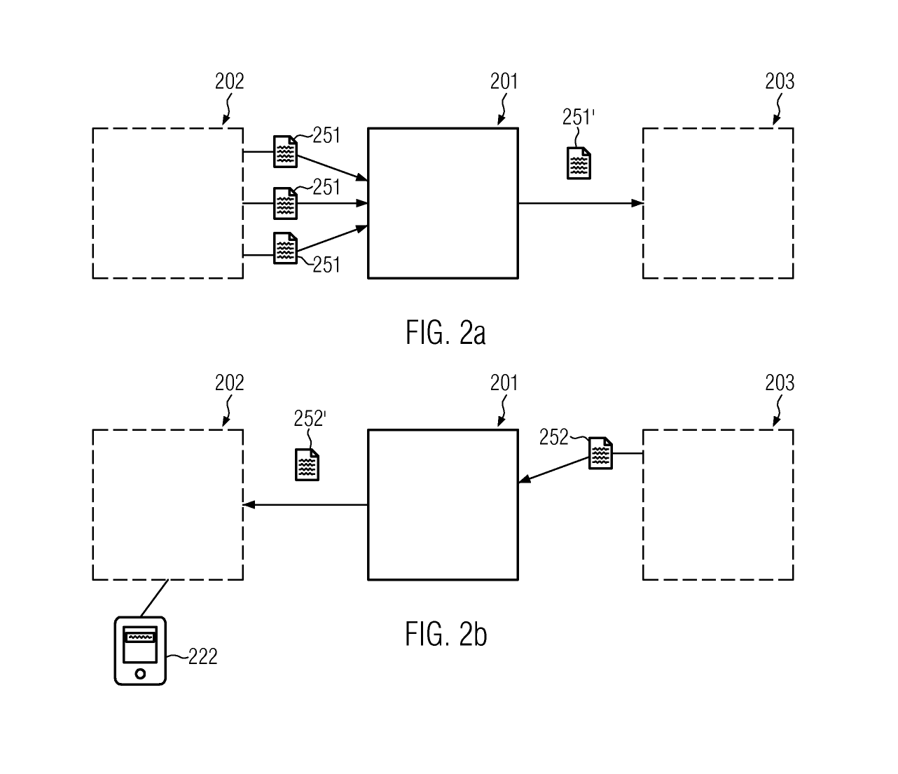

FIG. 2 shows a schematic depiction of the interaction of the server computer 201 with the first client 202 and the second client 203.

FIG. 2a shows how the server computer 201 obtains information from the first client 202 and transmit it to the second client 203. Further, the server computer 201 obtains, from the first client, pieces of information 251 (for example e-mails, instant messages in a social network, calendar entries, messages or the like) that are associated with a certain event in which the first client, in more detail the customer, indicated to be interested in participating. These obtained pieces of information 251 are then parsed in order to obtain precise event identifying information. Then, the server computer 201 accesses by transmitting credentials and, as far as necessary, information associated with the event 251′ to the second client 203, the database or the web portal associated with the second client 203.

FIG. 2b depicts the process of obtaining, from the second client 203, information and transmitting this information to the first client 201. Based on the credentials and the associated information 251′ of FIG. 2a, the server computer 201 obtains, from the second client 203, information associated with participating in a specific event 252. Since different providers may provide such information 252 in different formats, the server computer 201 does not transmit this information directly to the first client 202, i.e. the customer, but preferably reformats this information 252′ such that it can be viewed, for example, on the mobile device 222 in an appropriate format independent of the format in which the information 252 was originally provided. As an example, the second client 203 could provide the event-associated information 252 in the form of continuous text or a data string. This, however, may not be appropriate for a customer since the customer may only want to view essential details, for example the time and the location when and where the event takes place. Therefore, the server computer 202 reformats the information 252 obtained from the second client 203 such that a specific format is provided. This format, however, can depend on specific user requirements and, further, as will be explained below, on the state of, for example, the associated mobile device 222.

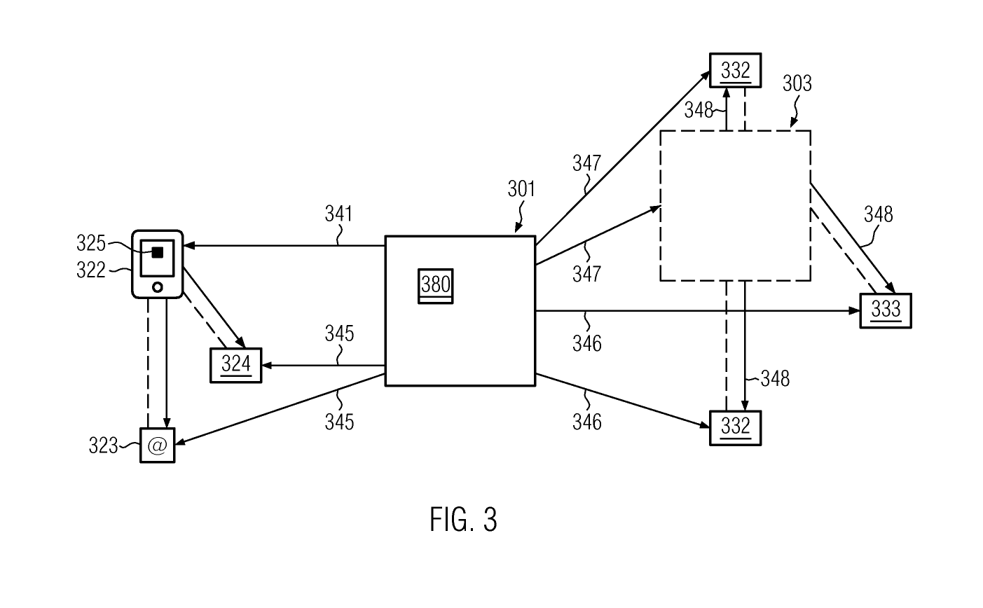

FIG. 3 is a schematic depiction on how the server computer 301 accesses information and the databases associated with the first client and the second client 303. In this case, the first client is represented by the mobile device 322 on which, preferably, an application 325 is installed that allows the customer to access the services of the server computer 301. In case the server computer 301 does not have access rights for accessing the databases on their own, i.e. without first acquiring the mobile device 322, the server computer 301 will access either, only information that is available on the mobile device 322 (for example e-mails stored in the inbox, messages, or the like), or it will access the external databases like social networks and e-mail accounts on e-mail servers via the mobile device 322. In case a profile 380 is stored on a storage medium associated with the server computer 301, it is possible to store in this profile credentials that allow the server computer 301 to access, via direct communication 245 with the social network 324 and e-mail account 323 for example the information stored in these databases. Similar access to other databases that might be of interest in order to obtain information of participation in a specific event can be acquired in the same ways. Therefore, the social network 324 and the e-mail account 323 may only serve as examples without further limiting the method.

On the other hand, with the information obtained from the first client 302, either by directly accessing databases via connections 345 or by acquiring the information on the databases via the mobile device 322, via the indirect connection 341, 342, and 343, the server computer 301 can access the second client 303 or its associated databases 332, 333, or 334 either directly or via a web interface. In case a web interface is provided no direct access to the databases of the provider of the event is necessary, as long as on the corresponding webpage of the web interface all necessary information is provided. By applying to the log-in of the webpage for example, the credentials that are stored in the user profile 380 or the server computer 301, the server computer 301 can access the second client 303 independent of the first client 302 at any point. Therefore, the customer does not need to take care that the participation validation is transmitted to the second client. Further, the method allows for the server computer 301 transmitting the participation validation to the second client 303 at a predetermined time and, at the same time or at another time, obtaining information related to validation. In the context of the invention, the participation validation may not only be limited to a specific format or a specific information. Depending on the restrictions provided by the second client 303, the participation validation can be understood as any interaction of the server-computer 301 with the second client 303 that is unambiguously associated with a specific first client (e.g. a specific customer) because credential information is applied or reference is made to a booking or reservation number.

Since the server computer 301 is a centralized location that can work independently from the first client and the second client, the information obtained from the second client can be stored in the profile of the first client or an associated storage in the server computer 301 and can be transmitted at the same predetermined time or another predetermined time to the first client without either client having to take any further action. In case the credentials stored in the profile 380 of the first client are such that access to the databases associated with the second client 303 can be performed directly, without using a web interface, transmitting the participation validation and obtaining the event-related information can be performed directly, which might be more reliable than obtaining the information via a third web portal that may not be directly provided by the second client, i.e. the provider of the event, but a third party.

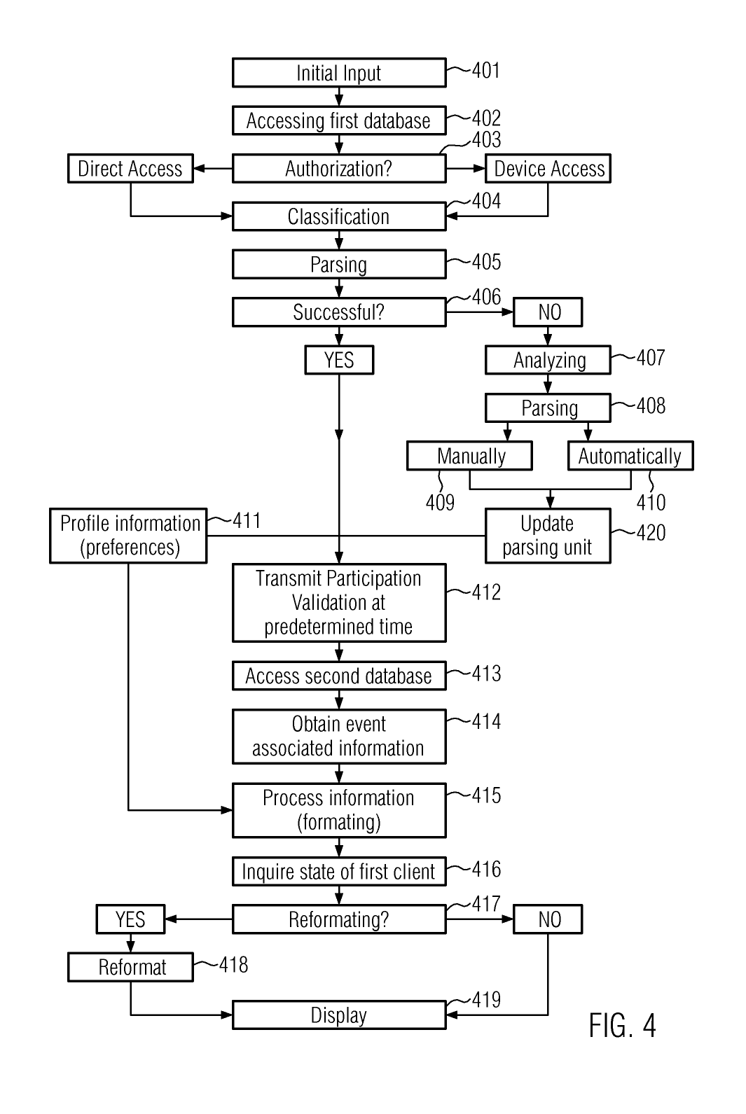

FIG. 4 shows a detailed flow diagram of the method for transmitting the participation validation and obtaining information related to a certain event. First, an initial input 401 informs the server computer that the first client intends to participate in a certain event. Such first initial input could, for example, if the server computer maintains permanent observation of social networks and e-mail accounts and associated databases, book confirmation of a flight. Such confirmation, or any other source that may serve initial input, will cause the server computer to access, in preferably predetermined time intervals, the first database, i.e. for example e-mail accounts of the first client. In order to do this, it is verified at step 403 whether or not the server computer has direct access to those databases.

In case he has no direct access, he either only obtains information that is stored on databases or devices which the server computer can access, like a smart phone or a notebook, or it accesses the databases through mobile devices like a smart phone. Having accessed the databases, the information that is stored in those databases is classified 404 whether or not it may be related to the event that was initially input. Such classification can be performed by a classifier. Such classifier can search, in unstructured data, like e-mails or the like, for specific keywords that may indicate that a specific e-mail is related to the event. Such keywords may be placed either in the subject of the e-mail or the contents or any other part of the e-mail (even attachments). The same holds for other data structures, that are associated with social networks for example. The keywords can be manifold, depending on which kind of event the first client or the customer intends to participate in. As an example, in case the clients wants to participate in a flight, keywords that might be relevant are words like “flight”, “booking”, “check-in” or the like. Further, the sender of the e-mail could be of interest because for example the name of the company can be included in this part of the e-mail like in any other part (subject, content, attachments, . . . ), indicating that the information in the e-mail or the like may be related to the event.

While a plurality of keywords can be used to determine whether data might be related to the event or not, not all of these keywords have the same likelihood to indicate that the data is indeed related to the event. As an example, the keyword “booking” mentioned above may relate to book any event not only to a flight specifically, whereas the word “flight” is at least related to any flight and therefore has a greater likelihood to be related to the specific flight. It might therefore be advantageous to provide statistic weights to the keywords and judge upon the keywords found in a data structure and their statistic weights whether the contents of the data structure is related to the event or not during the classifying step.

It will be preferred that the classifying scheme (i.e. the keywords that are deemed to indicate that data might be related to the event) is such that in the worst case, besides all relevant data also irrelevant data is classified as being related to the event. Be ensuring that all the relevant data is captured, at least no relevant information can be lost. Indeed it is a finding of the present invention, that including, in the classifying process, also data that might turn out to not be associated with the event in order to avoid erroneously missing relevant data improves the reliability of the method.

The information that may be related to the event is then parsed 405 in order to obtain from, for example e-mails that are related to the event, further event identifying information, like when, at the latest, the participation validation has to be sent to the second client.

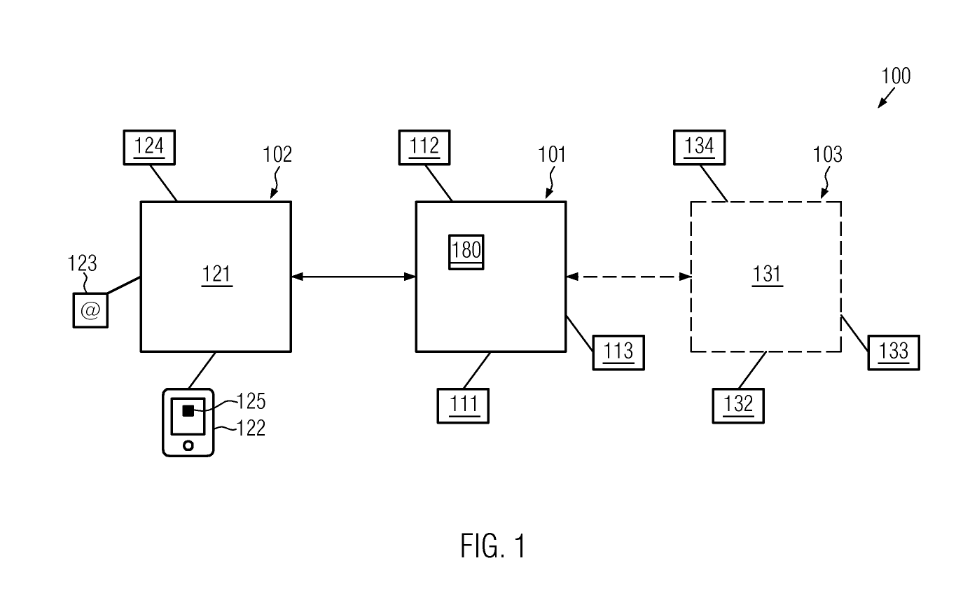

This parsing however may or may not be successful. Therefore, at step 406 it is determined whether or not parsing the classified information was successful in step 405. If it was, the method proceeds with sending the participation validation. If it was not, the information parsed for the first time can be analyzed at step 407 in order to obtain information on why parsing failed. Based on the reason for the failure and whether the failure can be determined at all, it is then decided whether parsing is repeated either manually at step 409 or automatically at step 410. If it was not possible during analysis 407 to obtain information on the reason for failure of the first parsing, or the reason for the failure during first parsing is such that it cannot be avoided by parsing the classified information again automatically, parsing at step 408 is conducted manually by an operator. In any case, overcoming this failure that occurred during the first parsing may lead to an improvement of the parsing unit described in FIG. 1 and, therefore, the solution obtained can be used to update the parsing unit 420. As an example, if the second client normally transmits an e-mail including the time by which the participation validation has to be transmitted being placed in the first line of the e-mail whereas, in the obtained e-mail this information was placed in the fifth line, first parsing may fail. However, by either manually or automatically parsing this information a second time after having analyzed the reason for the failure at step 407, including the information of the participation validation time limit being placed in the first or fifth line of the corresponding e-mail can help in improving the parsing unit. It is advantageous to not only consider, during parsing, information obtain from one source independent from the information obtained from another one (like e-mail account and social networks), but to link the pieces of information that were obtained. Even further it can be advantageous to link pieces of information obtained from one and the same source with each other. This will provide more reliable results.

Having parsed the information at step 408 and thereby obtained event identifying information, the participation validation is transmitted to the second client at a predetermined time 412 by an auto-filler that automatically fills in the required data. Together with this, certain profile information 411 (for example certain preferences of a customer) can be transmitted. It is obvious that transmitting the participation validation at a predetermined time must occur at a time before the event itself occurs.

While transmitting the participation validation 412 can cause errors at the side of the second client, this step may comprise further sub-steps like the parsing step 408 does. As an example, an error because of a time out of the request for sending a participation validation could occur. Therefore it is preferred that transmitting the participation validation optionally comprises confirming step in which the second client transmits to the server-computer either a confirmation that the participation validation was transmitted successfully, or a refusal of the participation validation. In such a case it is advantageous to provide an operator that conducts the transmission of the validation participation again. In order to do this, the operator is provided with the credential information stored in the profile 411 and for example the webpage or web portal of the second client to which the participation validation is to be transmitted. Advantageously both is provided on a split screen. The operator then manually performs the check-in. By doing so the operator can locate the reason for the participation validation being refused the first time and can provide a solution. This solution can be incorporated in the auto-filler which is updated thereby. Further errors that can be thought of are for example in case a PDF-document is used from which a code has to be extracted that has to be transmitted as participation validation, the provider of the event could have send an updated version of the PDF-document in which the code is placed at a different location in the document or includes a different number of signs, or the document itself is provided in a new/different format. Identifying such codes that are to be extracted from a document is achieved by using a sniper-unit. This unit might be incorporated in the auto-filler, but can also be provided as an independent component. Should the sniper-unit not recognize this difference in the documents, the operator can correct this error, thereby not only transmitting the correct participation validation, but also updating the sniper-unit in view of the new location of the code in the document. While the normal process-flow runs automatically, such special cases require input of the operator, which might be informed of the problem by automatically providing a “ticket” for example by the sniper-unit, the “ticket” including information on the problem that occurred.

Having transmitted the participation validation at step 412, the second database is accessed. This is achieved by not only transmitting the participation validation but also using either the profile information 411 stored in the server computer as described in FIG. 2 or by achieving access to those databases by acquiring the specific authorization from, for example, a smart phone. Having accessed the second database at step 413, event-associated information is obtained at step 414. This information may be provided in any format depending on the database. For example, if the second database corresponds to a service implemented on a webpage, it might be provided in the form of a table or documents that can be directly read by a customer. If the second database only includes abstract data structure (like a server structure of a flight company) this information may not be in condition to be viewed by a customer directly. However, this information obtained from any of the second databases can be processed at the server computer. Again, depending on profile information 411, the information is formatted such that it satisfies the requirements of the customer. This first processing of data may be applied in any case.

As an example, it might be necessary to extract a 2D-code from a document and display this to the first client (i.e. on the mobile device) because it might be required to identify the customer or verify that he has the permission to participate in the event.

In order to avoid errors due to mistakes in obtaining and displaying the event-associated information, it is advantageous to check the obtained information before transmission to the customer. This might be carried out by an automatic error-detection unit. For example, if it is detected, that the code which is to be extracted from the document is not complete (not sufficient number of signs, or there were more signs in the code than will be displayed) or it is not correct with respect to a reference pattern, an error message or ticket might be provided to an operator, who then performs further steps in order to ensure correct displaying of the event-associated information.

At step 416 the server computer may obtain information from the first client on the state of the device on which the information is to be displayed. For example, the server computer can obtain information regarding remaining battery service life. Depending on this information, at the formatting step 415 it is decided whether reformatting 417 is required. For example, during normal processing, information associated with the event is displayed on a mobile device via an application installed on said mobile device to the customer. If battery service life is so low that, at the predetermined time at which the information is to be displayed or at the time at which the event occurs the mobile device will most likely not be available, the information can be provided in the form of a printable document instead of a format that can only be viewed through the application. In any case, at step 419, the information is displayed.

It will be appreciated, that the steps of providing the participation validation and accessing the second database as well as obtaining the event information may be carried out in a different order depending on the access rights of the server-computer. For example, in case the server-computer has access to the second database without transmitting the participation validation, the server-computer may access the second database and obtain information before transmitting the participation validation.

It should be noted that, by including profile information 411 when transmitting the participation validation in order to indicate to the second client participation of the customer in the event, it is possible to automatically indicate participation without the customer having to interfere, but further it is possible to cause the second client to provide, at the time of the event, certain services based on the preferences of the customer, without having to require further input from the customer. Still further, again based on this profile information, not only the format of the event-related information can be determined but also, for example, certain conditions can be set under which the obtained information is to be shown or not. Further, it is possible to also set, in the profile information, certain conditions under which the participation validation may not be transmitted or a participation refusal may be transmitted in order to indicate to the second client that the first client will not participate in the event.

In the following, with reference to FIGS. 1-4, the method will be described in the example of booking a flight from location A to location B. In this case, the customer is indeed a person being equipped with, preferably, a smart phone or any other mobile device having installed thereon an application that allows for accessing the services provided by the server computer 101. Via this smart phone, the customer has access to databases that contain information associated with the customer, like social networks 124 or his e-mail account 123. By using the application 125, being installed on the mobile device 122, the customer may create a profile 180 within the server computer 101 at any time and only once. Within this profile, the customer may store credentials for accessing databases not only on his side but also on the side of the company providing the flight. For example, the customer may provide within this profile the nickname and the password for his social network account and his e-mail account. Further, he may grant the server computer access to his mobile device like smart phone 122. Still further, the customer may provide, within this profile 180, nickname and password information in order to access databases of the company that provides the flight, or other companies or a group of companies.

Among these databases, there might be a web portal that provides detailed information on the estimated time of departure of the aircraft and estimated time of arrival as well as information related to the check-in (for example when the check-in begins). Further, this webpage may be updated by the company at periodical intervals, like every 10 minutes. Having access to the databases associated with the first client on the one side and those associated with the company on the other side, the server computer interacts with the associated databases without having to inquire the customer. However, it is also possible that the customer provides, in his profile 180, information that he wants to be asked every time the server computer seeks access to a database.

In case the customer books a flight from location A to location B, the server computer 100 will either be informed by the customer himself through corresponding input information in the application 125 or through periodically accessing the databases associated with the customer. For example, it is common to send the customer a booking confirmation as soon as the customer books the flight. This booking information will be stored in the e-mail account of the customer, for example. Hence, it may also be stored on the smart phone 122. In any case, by accessing the devices and databases associated with the customer, the server computer can obtain this information by first classifying and then parsing the data obtained from the databases as described in FIG. 4. Having parsed the information, the server computer is preferably provided with enough information to proceed with transmitting the participation validation and providing the customer with the event-related information at a predetermined time, and in case it is not provided with sufficient information, the server-computer may access further databases or will link, during the parsing process, pieces of information obtained. For example, it might be indicated in the booking confirmation that the check-in starts 90 minutes before the estimated time of departure. Further, it is indicated that certain code or ticket (for example a 2D code or a picture or a barcode) has to be provided to the employees of the company in order to access the aircraft at the airport. Although this information may suffice in order to cause the server computer to provide the participation validation at a predetermined time sufficiently before the estimated time of departure (for example 90 minutes before, i.e. when the check-in begins), further information stored in the customer profile can be consulted by the server computer. For example, the customer could prefer to check-in as soon as possible in order to get a preferred seat, or to benefit from other possibly available upgrades. Therefore, in the customer profile, information may be stored that indicates where the customer wants to sit in the aircraft and at which time he preferably wants to check-in without requiring further input from the customer. This information can be used by the server computer to provide the participation validation to the company at the beginning of the check-in. If, on the other hand, the customer wants to check-in as late as possible, the customer may indicate this in his profile stored in the server computer 101 and the server computer will then automatically, depending on the information obtained from the second database, adjust the check-in time such that it is the latest time possible for this flight, without further acquiring information from the customer. In this context it can be advantageous to provide information to the user whether an additional service the user preferred was available or not. As an example, if the customer prefers to have a window seat, but none is available, the server computer may provide, via the application on the mobile device, information that no window seat was available. On the other hand, in case a window seat is available and can be booked in accordance with the preferences stored in the user profile, the server computer may book such a seat and inform the customer of the availability and that this additional service is already booked or the server computer may not inform the customer in case requested additional services can be booked

It is also possible to write the participation validation or refusal based on profile information and actual information that is obtained from, for example, the smart phone by the server computer. As an example, if the customer is at a location far from the airport when the check-in starts and the obtained information indicates that he will not participate in the flight, the server computer may automatically rebook this flight to a later time, cancel the flight altogether and send corresponding information to the customer that the flight was cancelled and/or rebooked. Thus, if the customer forgets about the flight beforehand, the server computer may at least inform the company of the fact that the customer will not participate.

Assuming that the customer wishes to participate in the flight and the participation information was sent at the predetermined time, the server computer obtains further information from the second database. Although the server computer already obtained information from the first database, information obtained from the second database may be in a more actual state or be more detailed, for example, the estimated time of departure of the aircraft may change some hours, or even minutes, before the original estimated time of departure. This information may be advantageously obtained from the second database which is, for example, the above-described webpage of the company providing the flight and might be automatically updated. Further, having stored detailed information on the flight, the server computer may also automatically access other information sources like the air cover and obtain information regarding a specific flight from this source of information. The obtained information, no matter from which source, is then processed by the server computer in order to be displayed to the customer in an appropriate manner. Again, depending on the profile information, the server computer may provide this information (for example display it on the smart phone) at a predetermined time. For example, the server computer may provide a reminder to the smart phone reminding the customer of the flight and when it is scheduled well ahead of the flight. Further, information or documents that are required to participate in the flight (for example an electronic airline ticket) can be provided via the application in an appropriate format. Further, if the server computer has accessed state information of the mobile device that is used, the server computer may provide this information, not only via displaying it on the smart phone but, for example, depending on the battery service life, as a printable version well ahead of battery failure in order to allow the customer to print the boarding card for the flight and/or the participation validation and/or any other document suitable for identifying himself as the passenger. Also, combinations of such displaying information can be thought of.

It should be noted that, although the described method was explained in the first part of this description in a more general way and only related to booking flight on an aircraft in the second part of the application, it is applicable without major amendments to booking a train ride or a boat ride or even a concert. Since all of those events are similar regarding the required information structures, the method is highly flexible and applies to a plurality of different events.

1. A method for providing a participation validation of a first client for participation in at least one event of a plurality of events to a second client and providing event information on the at least one event to the first client, the method comprising the following steps being performed by a server-computer:
accessing at least one first database comprising data associated with the first client;
classifying the data whether it may be related to participation in an event or not;
parsing the data that may be related to participation in an event in order to obtain event identifying information which identifies an event;
providing, to the second client, a participation validation at a predetermined time before the event occurs;
accessing at least one second database comprising data associated with the plurality of events;
obtaining event information associated with the event based on the parsed data; and
providing, to the first client, the event information on the event at a predetermined time before the event occurs, in a format that is independent of the accessed at least one second database and the second client.

2. The method according to claim 1, the at least one event being a flight, and the data related to the participation in the event is data related to booking the flight, and the participation validation of the first client being a check-in for the flight and the information associated with the event is a timetable for the flight.

3. The method according to claim 1, accessing the at least one first database comprising accessing at least one of a group including an e-mail-account, a social-network-account, a timetable, and calendar associated with the first client; and
accessing at least one second database comprises accessing at least one database of a provider of the event.

4. The method according to claim 1, and providing the event information comprises:
providing the event information in a printable format or a format that can be viewed on a mobile device associated with the first client, depending on the state of the first client.

5. The method according to claim 1, the event information further includes information on the requirements of the participation validation; and providing the event information includes providing information dependent on the requirements of the participation validation.

6. The method according to claim 1, parsing the data that is related to participation in the event comprises a first parsing step, the first parsing step being performed automatically by a parsing unit and yielding first parsed data;
an analyzing step, the analyzing step being performed automatically by an analyzing unit and yielding a judgement on whether the first parsed data is reliable or not, based on an analysis of the first parsed data;
and a second optional parsing step, being performed either manually (409) by an operator or automatically by the parsing unit on the first parsed data, based on the outcome of the analyzing step and yielding the parsed data; wherein the first parsed data of the first parsing step or the parsed data of the second optional parsing step contain the event identifying information.

7. The method according to claim 6, and the parsing unit is updated based on the parsed data obtained on the second parsing step.

8. The method according claim 1, and credential information for accessing the at least one first database is stored, at the server-computer, in a profile associated with the first client.

9. The method according to claim 1, and characterized in that providing, to the second client, a participation validation at a predetermined time before the event occurs comprises:
a first providing step in which a first participation validation is provided;
a confirming step in which the second client transmits to the server-computer a confirmation of the participation validation being valid or a refusal of the participation validation;
a second providing step which is carried out in case a refusal of the participation validation was sent and which is carried out manually by an operator that transmits a further participation validation to the second client and updates the server-computer upon the result.
